(19) United States
(12) Patent Application Publication
(10) Pub. No.: US 2008/0137329 A1
(43) Pub. Date: Jun. 12, 2008

(54) Vehicle locating device

(76) Inventor: Robert Fee, Apple Valley, CA (US)

Correspondence Address: EDWIN TARVER, 16830 Ventura Blvd., SUITE 360, Encino, CA, 91436, US

(21) Appl. No.: 11/638,344

(22) Filed: Dec. 11, 2006

(51) Int. Cl. F21V 21/00

(52) U.S. Cl. 362/231; 362/249; 362/252

(57) ABSTRACT

A device for identifying a campsite or a vehicle comprising a pole, a plurality of light emitting diodes (LEDs) disposed around the pole forming multiple arrays located one below the other, a power supply means, and a control means for producing various light patterns by selectively controlling power supply to the LEDs. The device also includes switches to select the light pattern.

### CROSS-REFERENCE TO RELATED APPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to devices for identifying vehicles, and more particularly to a device with illuminating features for identifying campsites and recreational vehicles.

Devices for locating a vehicle in parking areas are known in art. For example, U.S. Pat. No. 6,580,368 to Jacobs discloses a vehicle locator device for finding a parked vehicle in a parking lot or garage during the nighttime. The device consists of a remote controlled key chain, a remote controlled light that will be placed inside or outside the vehicle and a remote controlled haze machine which will be placed on the outside top of the vehicle. When a button on the remote controlled key chain is pressed, a signal is sent to the remote controlled light and haze machine. After receiving the signal, the remote controlled light will send a beam of light above the vehicle and the remote controlled haze machine will send a puff of mist above the vehicle.

U.S. Pat. No. 6,298,803 to Gregg discloses a car locator that uses a pluraity of visual indicators to help the owner locate a car in a crowded parking lot. The car locator comprises a bracket means for attachment to a car window, a mast attached to the bracket means, a flag attached adjacent a top of the mast, and a string of lights wrapped around the mast. A battery box is electrically connected to the lights. The battery box is secured between the bracket means and the mast. The battery box has a switch means for turning on and off the lights.

U.S. Pat. No. 5,089,803 to Bohn discloses a vehicle identifying apparatus comprising a base holding unit, flagstaffs that can be removably and securely held to the base holding unit, and an electric light system. The electric light system comprises a battery pack affixed to the base holding unit, parallel electrical wiring connecting the battery pack to electric light units, and an easily removable connection connecting the parallel wiring and the battery pack. The electric light units can be mounted to the flagstaffs.

The present invention is different from the above devices in that it comprises different construction and is capable of producing several light patterns selectable by the user for identifying a vehicle or campsite. The device of the present invention is simple to construct. The main components of the present invention comprise Light emitting diodes, a microcontroller and PVC pipes, PVC couplers, and PVC adapters, all of which are readily available.

### SUMMARY

The present invention is a device for locating campsites and recreational vehicles, especially during nighttime. The device comprises a pole, a plurality of light emitting diodes on the pole, a power supply means and a microcontroller connected to the LEDs to control their power supply. The LEDs are disposed around the pole in multiple arrays. The control means is capable of producing several light patterns by selectively controlling power supply to the light emitting devices. The LEDs in an array are controlled together. Switches are provided to select the type of the light pattern. The device of the present invention is constructed from components comprising PVC pipes, couplers and adapters.

### BRIEF DESCRIPTION OF THE FIGURES

FIG. 1 is a perspective view of the device of the present invention.

FIG. 2 is a perspective view of the first and second sleeve-like members.

FIG. 3 is a perspective view of the third sleeve-like member with drilled holes.

FIG. 4 is a perspective view of the third sleeve-like member with LEDs.

FIG. 5 is a perspective view of an array comprising the LEDs and the sleeve-like members.

FIG. 6 is a plan view of the pipe.

FIG. 7 is a plan view of the pipe with the arrays above the holes.

### FIGURES—REFERENCE NUMERALS

10—Device of the Present Invention
12—Pipe
14—First Sleeve-like Member
16—Second Sleeve-like Member
18—Third Sleeve-like Member
20—Hole on the Third Sleeve-like Member
22—Light Emitting Diode
24—Hole on the Pipe
26—Wiring
28—Microcontroller
30—Switch
32—Fused Cigarette Lighter Plug and Cord

### DETAILED DESCRIPTION

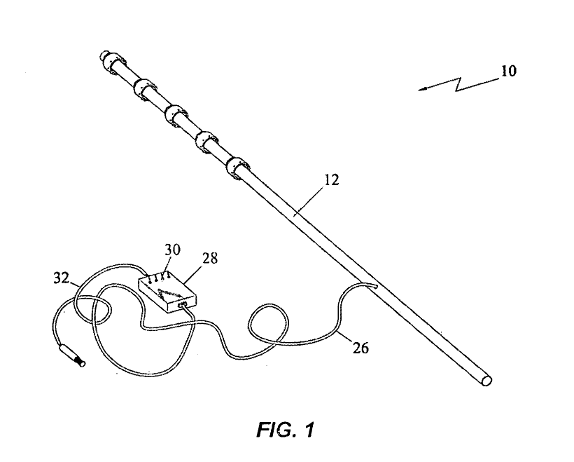

Referring to the drawings, a preferred embodiment of a device of the present invention is illustrated and generally indicated as 10 in FIGS. 1 through. The device is used for identifying campsites and recreational vehicles.

The device comprises a pole, a plurality of light emitting diodes (LEDs), and a microcontroller. The light emitting diodes are disposed around the pole in multiple arrays. The device including five arrays of LEDs is used to explain its construction.

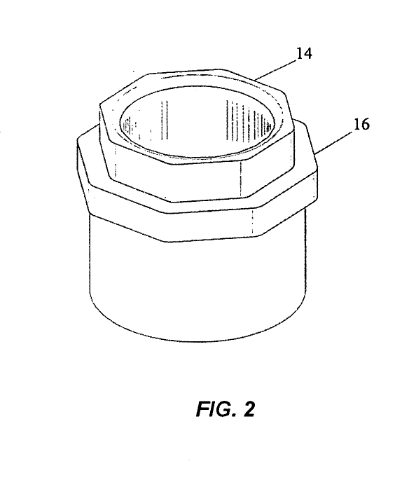

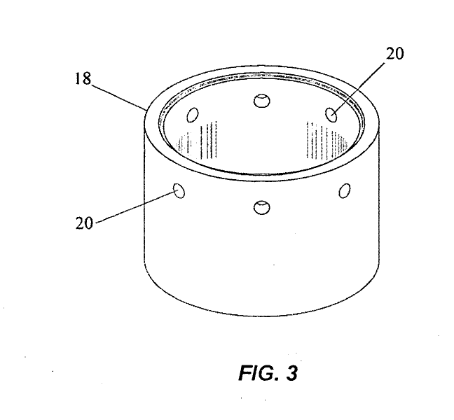

Referring to FIGS. 1 through 3, in a preferred embodiment, the device 10 is constructed from a 10 feet PVC pipe 12 and a plurality of PVC sleeve-like members. To construct an array of LEDs, three sleeve-like members, namely, first, second, and third are used. The first sleeve-like member 14 is capable of snugly receiving the pipe 12. The second sleeve-like member 16 is adapted to be received over the first sleeve-like member 14. Preferably, the first and second sleeve-like members comprise PVC adapters and the third sleeve-like member 18 comprises a PVC coupler. The third sleeve-like member 18 is capable of receiving the second sleeve-like member 16.

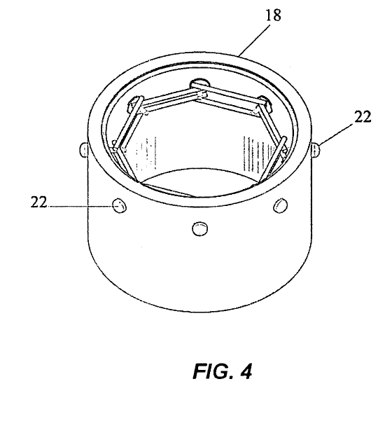

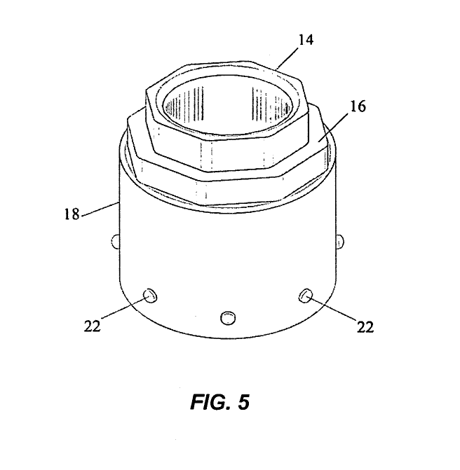

Referring to FIGS. 4 through 5, available PVC couplers and adapters can be used for the sleeve-like members. They can be cut to suitable lengths such that a portion of the third sleeve-like member 18 surpasses the first and second sleeve-like members. This portion is drilled with holes 20 for snugly receiving the LEDs 22. The LEDs 22 are connected in parallel. The anode and cathode sides of the LED array are soldered with a two inch lead. After the LEDs are secured, the second sleeve-like member is inserted into the third sleeve-like member, thereby forming an array. PVC glue is used to permanently secure the sleeve-like members. The LEDs can also be permanently secured using appropriate glue (super glue). In this way, five arrays are constructed, each having one row of LEDs.

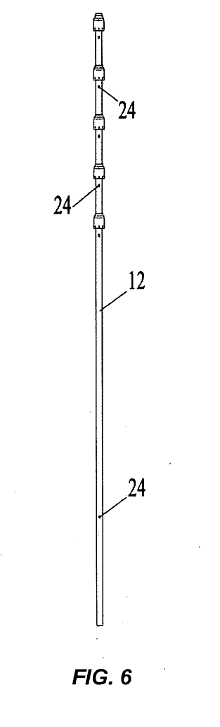

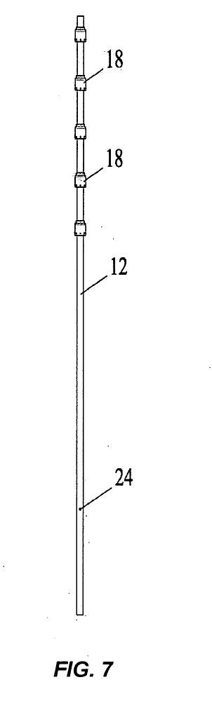

Referring to FIGS. 6 through 7, six holes 24 are drilled on the top portion of the PVC pipe. Top five holes are used to connect the five arrays of LEDs to wiring. The wiring 26 comprises ten individual wires (not shown) of different colors for connecting anode and cathode sides of the five arrays. For instance, a black wire for connecting the anode side of the topmost array and a yellow wire for connecting the cathode side of the topmost array. The colored wires therefore help in representing the array to which they are connected. A 50 ohm 2w resistor is soldered to each wire intended for connection to the cathode side of the arrays. The resistors are covered with a tape.

The wiring 26 is passed from the top of the pipe and pulled out from the sixth hole at the bottom of the pipe. The arrays comprising the LEDs and the sleeve-like member are slid over the pipe. Each array is positioned above one of the top five holes 24. The colored wires are pulled out little bit from the holes and connected to the anode and cathode sides of the arrays. Tapes are used to cover and insulate the connections between the wires and the arrays.

The colored wires coming out from the sixth hole are connected to the microcontroller 28. The microcontroller is programmed to selectively control power supply to the LEDs to produce various light patterns. Multiple light patterns can be selected through a series of switches 30. In a preferred embodiment, power is supplied to the microcontroller and the LEDs by a fused cigarette lighter plug and cord 32. A voltage regulator can be used for converting and making the supplied voltage suitable for the microcontroller.

In one embodiment, a PIC18F2520 microcontroller is used. The wires are connected to pins of DB-9 connector. 12 volts is supplied to each of the five arrays. The arrays are supplied 12v by 4 pins in the DB-9 connector, with two of the arrays sharing a common 12v pin in the DB-9 connector. Port C of the PIC 18F2520 microcontroller is used for input on pins 11, 12, 13, 14. These four input switches give 16 different inputs to the PIC 18F2520. Pins are held at 5v high through resistors connected to +5v. When a switch is turned on, the voltage on a corresponding pin drops to 0v. Switches are connected to ground and pins 11 to 14 are held high by the pull-up resistors until the switch is turned on, grounding the pin of the respective input pin resulting in 0v input to the microcontroller. Port B of the PIC 18F2520 microcontroller is used for output on pins 21, 22, 23, 24, 25. There are five npn transistors and five current limiting resistors corresponding to the five arrays. Pins are held low by the microcontroller unless an LED array is commanded on. When commanded on, 5v is applied to a transistor through a current limiting resistor. The transistor is then turned on, grounding a corresponding LED array, thereby illuminating the array. For example, pin 21 will be held low by the microcontroller unless the first LED array is commanded on. When commanded on, 5v is applied to a first transistor through a first current limiting resistor. The first transistor is then turned to illuminate the first array.

The device is installed on or near the vehicle. In an alternate embodiment, instead of using the 10 feet pipe, the device can be made by using a shorter pipe of around 4 feet in length and with lesser number of arrays. A magnetic mount can be used to secure the device to the vehicle.

The LEDs can comprise different colors and can also be arranged in two or more rows on the third sleeve-like members. For aiding storage and shipping, the lower portion of the pipe can be designed to be detachable. An infrared or Radio Frequency remote control device associated with the microcontroller can be used to select the light pattern.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A device for identifying a campsite or a vehicle, comprising:
(a) a pole;
(b) a plurality of light emitting devices disposed around the pole forming multiple arrays located one below the other;
(c) a power supply means; and
(d) a control means for producing various light patterns by selectively controlling power supply to the light emitting devices.

2. The device of claim 1, wherein the light emitting devices of an array are controlled together by the control means.

3. The device of claim 1, wherein a group of the arrays are controlled together by the control means.

4. The device of claim 1, wherein the light emitting devices comprise light emitting diodes (LEDs).

5. The device of claim 4, wherein the light emitting diodes comprise different colors.

6. The device of claim 1, wherein the control means comprises a means for selecting the light patterns.

7. The device of claim 6, wherein the means for selecting the light patterns comprises a plurality of switches.

8. The device of claim 1, wherein a remote control device associated with the control means is used for selecting the light patterns.

9. The device of claim 1, wherein the control means comprises a microcontroller.

10. The device of claim 1, wherein the pole is hollow and wiring connecting the light emitting devices and the control means is routed through the hollow interior of the pole.

11. The device of claim 1 further comprises a mounting means for disposing the light emitting devices around the pole.

12. The device of claim 11, wherein the mounting means comprise a plurality of sleeve-like members incorporating the light emitting devices, the sleeve-like members are secured to the pole after receiving the pole.

13. The device of claim 12, wherein an array comprises all the light emitting devices mounted to a sleeve-like member.

14. The device of claim 1 further comprises a mounting means for each array of the light emitting devices, each of the mounting means comprising:
(a) a first sleeve-like member received and secured over the pole;
(b) a second sleeve-like member received and secured over the first sleeve-like member; and
(c) a third sleeve-like member lengthier than the first and second sleeve-like members and received and secured over the second sleeve-like member such that a gap is maintained between its inner surface and the pole.

15. The device of claim 14, wherein the light emitting devices comprise light emitting diodes (LEDs) and the portion of the third sleeve-like member surpassing the first and second sleeve-like members comprises holes for snugly receiving the LEDs.

16. The device of claim 15, wherein the pole is hollow and wiring connecting the LEDs and the control means is routed through the hollow interior of the pole.

17. The device of claim 14, wherein the pole comprises a PVC pipe, the first and second sleeve-like members comprise PVC adapters, and the third sleeve-like member comprises a PVC coupler.

18. The device of claim 1, wherein the pole is vertically oriented and the light emitting devices are disposed on the upper portion of the pole.

19. The device of claim 1, wherein the power supply means comprises a fused cigarette plug and cord.
